(19) United States
(12) Patent Application Publication
(10) Pub. No.: US 2024/0343245 A1
(43) Pub. Date: Oct. 17, 2024

(54) METHOD FOR OPERATING A MOTOR VEHICLE, CONTROL UNIT, AND MOTOR VEHICLE

(71) Applicant: Volkswagen Aktiengesellschaft, Wolfsburg (DE)

(72) Inventors: Falk-Christian BARON VON CEUMERN-LINDENSTJERNA, Braunschweig (DE); Michael KROEGER, Brome (DE); Lars KOEPPEL, Braunschweig (DE)

(73) Assignee: Volkswagen Aktiengesellschaft, Wolfsburg (DE)

(21) Appl. No.: 18/638,157

(22) Filed: Apr. 17, 2024

(30) Foreign Application Priority Data
Apr. 17, 2023 (DE) 10 2023 203 432.8

(51) Int. Cl. B60W 20/16; B60W 10/06; B60W 10/08; B60W 20/40

(52) U.S. Cl. CPC B60W 20/16; B60W 10/06; B60W 10/08; B60W 20/40; B60W 2510/244; B60W 2555/20; B60W 2556/10; B60W 2556/50; B60W 2710/0677; B60W 2710/0694; B60W 2710/086

(57) ABSTRACT

A method for operating a motor vehicle having an internal combustion engine. The internal combustion engine is started. A drive power requirement is ascertained. A takeoff delay for reaching a predetermined minimum temperature for an exhaust aftertreatment system is determined, the predetermined minimum temperature being a function of a setpoint internal combustion motor drive power that is to be provided by the internal combustion engine to meet the drive power requirement. After the takeoff delay elapses, a release signal for releasing a takeoff block is outputted. Provided is also a control unit and a motor vehicle.

This nonprovisional application claims priority under 35 U.S.C. § 119 (a) to German Patent Application No. 10 2023 203 432.8, which was filed in Germany on Apr. 17, 2023, and which is herein incorporated by reference.

### BACKGROUND OF THE INVENTION

### Field of the Invention

The invention relates to a method for operating a motor vehicle, in particular for determining a variable takeoff delay, to a control unit, and to a motor vehicle.

### Description of the Background Art

The Euro 7 exhaust emission standard requires a further reduction in pollutant emissions (NOx, particulate matter, CO, etc.) during operation of a vehicle. In principle, in a vehicle having an internal combustion engine this reduction takes place using an exhaust aftertreatment system situated in an exhaust tract downstream from the internal combustion engine. For effective action of the exhaust aftertreatment system, it is necessary to bring it to an operating temperature at which a sufficient conversion readiness for converting the pollutants in the exhaust gas is present. For this reason, in particular the efficiency of the exhaust aftertreatment system is comparatively low immediately after a cold start, since the required operating temperature is not yet present.

It is therefore known to heat up the exhaust aftertreatment system prior to beginning a trip.

Thus, DE 10 2018 111 259 A1, which corresponds to US 2018/0334170, discloses a system and a method for preconditioning an aftertreatment catalytic converter in response to a preconditioning signal that predicts a start time of the vehicle. The preconditioning takes place prior to the start time and corresponding to a conditioning profile, a state of charge of a vehicle battery, and an external power signal that indicates whether, and if so, how much, power is available from an external power source.

DE 10 2019 203 598 A1, which correspons to US 2020/0298701, discloses a method for operating a motor vehicle having an internal combustion engine, in which prior to a takeoff of the motor vehicle, preheating measures are taken for reaching operating temperatures for components of the exhaust aftertreatment system and/or for a lambda sensor of the motor vehicle. In particular to avoid the unnecessary initiation of preheating measures, it is provided for the driver of the motor vehicle to actuate a signal generator for explicit notification of an imminent takeoff of the motor vehicle as a trigger for the preheating measures. In addition, it is described that the takeoff of the motor vehicle and/or starting of the engine are/is delayed in order to reach required operating temperatures.

In principle, compliance with the Euro 7 emission standard requires a rapid heatup of the exhaust aftertreatment system, at the same time with the lowest possible pollutant emissions during the cold start phase. Therefore, excessive power, which would also result in increased uncontrolled emissions, must not be released during the cold start phase.

In order to comply with the Euro 7 emission standard, it will be necessary, as a function of further constraints, to prevent the vehicle from taking off, i.e., to provide for a takeoff delay, for a predetermined time after the (driver's) intent to start. It may thus be ensured that excessive pollutants are not emitted until the conversion readiness of the exhaust aftertreatment system is sufficient.

However, a takeoff delay for a running or stationary internal combustion engine as well as limitation of power are measures that are expected to have very low customer acceptance.

### SUMMARY OF THE INVENTION

It is therefore an object of the present invention to provide a method, a control unit, and a motor vehicle that at least partially overcome the disadvantages stated above.

A first aspect of the invention relates to a method for operating a motor vehicle having an internal combustion engine. The method comprises: starting an internal combustion engine, ascertaining a drive power requirement, determining a takeoff delay for reaching a predetermined minimum temperature for an exhaust aftertreatment system, the predetermined minimum temperature being a function of a setpoint internal combustion motor drive power that is to be provided by the internal combustion engine to meet the drive power requirement; and outputting, after the takeoff delay elapses, a release signal for releasing a takeoff block.

For the design of a takeoff delay, the amount of power to be released after the takeoff delay is critical. That is, the length of the takeoff delay is a function of the drive power requirement. The longer the takeoff delay, the more drive power that may be released during the takeoff. A waiting period is ended (i.e., the takeoff delay elapses) and the motor vehicle is allowed to take off only after a certain minimum drive power threshold of the internal combustion engine can be released under these criteria.

The duration of the takeoff delay should be as short as possible for customer acceptance reasons. A time of the takeoff delay that is always fixed is not desirable. This is because if the driver requires only very little drive power after takeoff, it is desirable for the takeoff delay to be shorter for the takeoff. In contrast, if the driver requires more drive power, the takeoff delay is longer. The present method now decides, based on criteria, whether the driver is expected to require a low or high drive power, and dynamically controls or determines the corresponding takeoff delay.

The internal combustion engine may be designed as a gasoline engine or a diesel engine.

The starting of the internal combustion engine corresponds to starting after a preceding vehicle standstill in which the internal combustion engine was in a switched-off or non-active state. The starting of the internal combustion engine may be carried out in response to a corresponding start signal. The start signal is output based on an ignition switch activation, an accelerator pedal activation, or some other intent to start by the driver.

At the same time that the internal combustion engine is started, a blocking signal may be output which activates a takeoff block and thus prevents the motor vehicle from taking off. The blocking signal serves to delay or prevent takeoff until the exhaust aftertreatment system of the motor vehicle reaches a predetermined minimum temperature and thus, a predetermined conversion readiness for pollutants.

For heating up the exhaust aftertreatment system, the internal combustion engine may be operated in an idle mode after starting.

The exhaust aftertreatment system is situated in an exhaust tract downstream from the internal combustion engine, and is configured to reduce pollutants in the exhaust gas emitted by the internal combustion engine. For this purpose, the exhaust aftertreatment system includes a catalytic converter. For reducing the pollutants, the exhaust aftertreatment system must be heated to the predetermined minimum temperature. The predetermined minimum temperature for the exhaust aftertreatment system is a function of how much drive power is to be provided by the internal combustion engine (setpoint internal combustion engine (ICE) drive power) to meet the drive power requirement.

The drive power requirement indicates the level of (expected) drive power that is required by the driver after the motor vehicle takes off.

The drive power requirement may be ascertained based on a criterion that is indicative of a drive power requirement. The criterion may be selected from a plurality of criteria that are indicative of a drive power requirement. These criteria may include, for example, navigation data, vehicle position, user history, ambient temperature, vehicle operating mode, etc. These criteria are explained in greater detail below.

The takeoff delay is determined based on the setpoint ICE drive power that is to be provided to meet the drive power requirement. The takeoff delay is a time requirement or time period that is necessary for reaching the predetermined minimum temperature of the exhaust aftertreatment system. During the takeoff delay the motor vehicle is prevented from taking off, and thus remains at a standstill with the internal combustion engine running, and the exhaust aftertreatment system is thus heated up by the exhaust gas.

The predetermined minimum temperature corresponds to a temperature at which the exhaust aftertreatment system reduces the pollutants in the exhaust gas exhaust gas to the extent that the pollutant emissions are below a predetermined threshold value.

The predetermined minimum temperature is a function of the setpoint ICE drive power. The lower the setpoint ICE drive power, the lower also is the amount of pollution in the exhaust gas. Consequently, the required efficiency and thus the required temperature of the exhaust aftertreatment system for reducing the pollutants to the predetermined threshold value are also lower. Conversely, the higher the setpoint ICE drive power, the greater is the amount of pollution in the exhaust gas. As a result, the required efficiency and thus the required temperature of the exhaust aftertreatment system for reducing the pollutants to the predetermined threshold value are also higher.

The takeoff delay is thus a function of the predetermined minimum temperature, which in turn is a function of the setpoint ICE drive power for meeting the drive power requirement. Therefore, the takeoff delay is dependent on the drive power requirement.

After the takeoff delay is determined, there is a waiting period until the takeoff delay has elapsed. A release signal for releasing the takeoff block is subsequently output in response to the elapse.

The present method ascertains the drive power requirement and thus dynamically controls the takeoff delay. In particular, inclusion of the described criteria results in a dynamic takeoff delay, and thus in a possible shortening of the takeoff delay as a customer convenience function.

The drive power requirement may be a function of at least one of the following criteria: navigation data; vehicle position; user history; ambient temperature; and/or vehicle operating mode.

The navigation data may include, for example, the speed limit on a first section of the route that must be traveled, after the motor vehicle takes off, to reach the route destination. A drive power requirement for the first section may be ascertained in this way.

The vehicle position indicates the position of the motor vehicle at a given moment. On this basis, conclusions may be drawn concerning the level of the drive power requirement. Depending on which zone the motor vehicle is in at the time, a corresponding speed limit may be provided, and a corresponding drive power requirement may thus be necessary. If the motor vehicle is, for example, in a zone having a speed limit in the low speed range (less than or equal to 30 km/h, for example), it may be assumed that a comparatively low drive power requirement is present for the takeoff. If the vehicle is stopped in the vicinity of an expressway, presence of a comparatively high drive power requirement is expected. In addition, the vehicle position may be used to derive a present slope of the roadway on which the motor vehicle is on at the time. A fairly large slope may require more drive power.

The user history indicates the behavior of the driver in the past. On this basis, for example the level of the drive power requirement of the driver after taking off may be derived. For this purpose, recordings regarding an acceleration behavior of the motor vehicle may be acquired and evaluated by the driver. The user history may also include user-defined preferences regarding the drive power requirement.

The ambient temperature or the outdoor temperature may likewise influence the pollutant emissions. Thus, the ambient temperature influences the temperature of the internal combustion engine, which in turn influences the fuel combustion (when starting the engine, for example) and thus the pollutant emissions. For example, a certain temperature of the internal combustion engine may result in impairment of the combustion, and thus, worsening of the pollutant emissions.

Furthermore, the criterion may be recognition of a vehicle operating mode, for example towing a trailer, that has a higher drive power requirement.

Based on these criteria, the dynamic determination of the takeoff delay may be further specified.

The method may also comprise: ascertaining a summed drive power for meeting the drive power requirement, the summed drive power comprising the setpoint internal combustion motor drive power and a setpoint motor drive power, where the setpoint motor drive power is to be provided by an electric machine of the motor vehicle.

The electric machine is situated in the motor vehicle and is coupled to an electrical energy store. The electric machine is arranged in the drive train in such a way that it (in addition to the internal combustion engine) can make a contribution to the drive power. For example, the motor vehicle may be designed as a P1 hybrid, in which the electric machine is situated at the internal combustion engine. The electric machine may be directly coupled to the crankshaft of the internal combustion engine. Alternatively, the electric machine, as a belt starter generator, may be coupled to the crankshaft. In other examples, the motor vehicle may have some other parallel hybrid arrangement (P2, P3, or P4).

The summed drive power is made up of the setpoint motor drive power and the setpoint ICE drive power, and corresponds to the power necessary to meet the drive power requirement. In some circumstances the portion of the motor drive power may also be zero, for example if the state of charge of the energy store is too low, so that the electric machine cannot provide drive power.

The takeoff delay may be further reduced by decreasing the setpoint ICE drive power for implementing the drive power requirement, and compensating for the decreased setpoint ICE drive power via the setpoint motor drive power.

The setpoint motor drive power may be a function of a state of charge of the energy store of the motor vehicle that is coupled to the electric machine. The motor drive power in principle is a function of the state of charge of the electrical energy store. That is, the setpoint motor drive power may be determined depending on the state of charge of the electrical energy store.

The motor drive power may be a function of a hybrid operating strategy of the motor vehicle. A hybrid operating strategy is understood to mean an operating mode of the drive train, i.e., whether a driving mode that involves strictly internal combustion engine operation, strictly electrical operation, or a hybrid mode is present. For example, the hybrid operating strategy may be that for a first predetermined state of charge of the electrical energy store, only the strictly internal combustion engine driving mode is provided, so that the setpoint motor drive power is equal to zero and the drive power requirement must be met solely by the ICE drive power. The hybrid operating strategy may also be that for a second predetermined state of charge of the electrical energy store, the hybrid driving mode may be applied.

The method may also comprise: heating the exhaust aftertreatment system to the predetermined minimum temperature using measures on the internal combustion engine side.

Measures on the internal combustion engine side are understood to mean those that require no additional external heating device for heating up the exhaust aftertreatment system. For example, a temperature of the exhaust gas may be provided by adjusting the ignition angle in the retarded direction and/or increasing the idling speed of the internal combustion engine. If is thus possible to more quickly heat the exhaust aftertreatment system to the predetermined minimum temperature.

The takeoff delay may be a function of an actual temperature of the exhaust aftertreatment system. In particular after a brief standstill phase, the exhaust aftertreatment system may still contain residual heat from a previous driving mode. This correspondingly shortens the time necessary for heating the exhaust aftertreatment system to the predetermined minimum temperature. The takeoff delay may be determined more accurately by taking the actual temperature into account.

The takeoff delay may be determined based on a characteristic map. The characteristic map may be ascertained, for example, via tests on a test stand. A relationship between the drive power requirement and a necessary time period required for reaching the predetermined minimum temperature (takeoff delay) is stored in the characteristic map.

The takeoff delay may be determined based on a physical model. In this case, complicated testing to create a characteristic map may be avoided.

A second aspect of the invention relates to a control unit that is configured to carry out one of the methods described above.

A third aspect of the invention relates to a motor vehicle that includes the above-described control unit, the motor vehicle being configured to carry out one of the methods described above.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a motor vehicle together with an exhaust aftertreatment system; and

FIG. 2 shows a block diagram of a method for operating the motor vehicle from FIG. 1.

### DETAILED DESCRIPTION

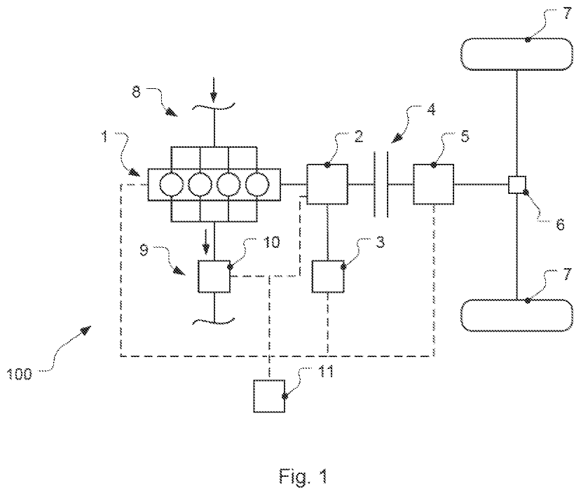

FIG. 1 schematically shows a motor vehicle 100 having an internal combustion engine 1. The internal combustion engine 1 may be designed as a gasoline engine or diesel engine. The internal combustion engine 1 is coupleable to a transmission 5 via a clutch 4 for a transfer of drive power. The transmission 5 may be designed, for example, as a dual clutch transmission or an automatic transmission. A manual switch with an e-clutch may be provided for actuating the clutch 4. The transmission 5 transfers the drive power of the internal combustion engine 1 to the drive wheels 7 via a differential 6.

The motor vehicle 100 also includes an electric machine 2 on the drive train side. The electric machine 2 is connected to an electrical energy store 3 that supplies the electric machine 2 with electrical energy. In the example shown in FIG. 1, the motor vehicle is designed as a mild hybrid (mHEV), the electric machine 2 acting on the crankshaft of the internal combustion engine 1. The electric machine 2 may be designed as a belt starter generator, for example, or may be situated directly on the crankshaft.

In an example not shown, the electric machine 2 may be situated in some other arbitrary parallel arrangement with respect to the internal combustion engine 1, and for example may be provided in addition to a belt starter generator. In other examples, the motor vehicle 100 may be designed as a plug-in hybrid (PHEV).

The electric machine 2 may likewise provide a drive power (motor drive power) for meeting a drive power requirement in addition to an ICE drive power of the internal combustion engine 1.

The internal combustion engine 1 is supplied with fresh air via a fresh air supply 8 for combustion in cylinders of the internal combustion engine 1. The exhaust gas produced by the combustion is discharged from the internal combustion engine 1 via an exhaust tract 9. An exhaust aftertreatment system 10 that includes a catalytic converter is provided in the exhaust tract 9 for aftertreatment of the exhaust gas, in particular for reduction of pollutants.

In addition, a control unit 11 is provided in the motor vehicle 100 for monitoring and/or controlling the internal combustion engine 1, the electric machine 2, the electrical energy store 3, the transmission 5, and the exhaust aftertreatment system 10.

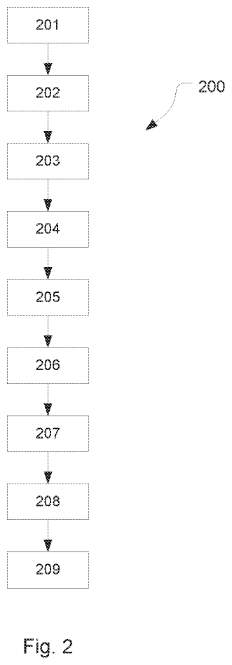

For sufficient pollutant reduction, the exhaust aftertreatment system must be heated to a predetermined minimum temperature. The method 200 shown in FIG. 2 is applied to ensure sufficient heating time after the motor vehicle 100 is started.

The internal combustion engine 1 is started in block 201. At the same time, a blocking signal may be output by the control unit 11 which activates a takeoff block for the motor vehicle 100 and thus prevents the motor vehicle 100 from taking off.

A drive power requirement that is expected to be necessary after the motor vehicle 100 takes off is ascertained in block 202. The drive power requirement may be ascertained based on at least one of the following criteria: navigation data, vehicle position, user history, ambient temperature, and vehicle operating mode.

A setpoint motor drive power that is to be provided by the electric machine 2 to meet the drive power requirement is ascertained in optional block 203. The setpoint motor drive power may be a function of a state of charge of the electrical energy store 3. The setpoint motor drive power may be zero, for example if the state of charge of the electrical energy store 3 is not sufficient to operate the electric machine 2 as a drive motor.

A setpoint ICE drive power that is to be provided by the internal combustion engine 1 to meet the drive power requirement is ascertained in block 204.

A summed drive power is ascertained in optional block 205. The summed drive power comprises the setpoint ICE drive power and the setpoint motor drive power. In examples in which no motor drive power is provided, block 205 may be dispensed with. In some examples, the setpoint motor drive power is equal to zero, in which case the summed drive power corresponds to the setpoint ICE drive power.

The predetermined minimum temperature for the exhaust aftertreatment system 10 for effective pollutant reduction is ascertained in block 206, the predetermined minimum temperature being a function of the setpoint ICE drive power.

The takeoff delay for reaching the predetermined minimum temperature is ascertained in block 207. The takeoff delay may be ascertained from a characteristic map, for example, in which takeoff delays in relation to a predetermined minimum temperature are stored. In addition, the takeoff delay may also be a function of the actual temperature of the exhaust aftertreatment system 10.

The exhaust aftertreatment system 10 is heated up in block 208, during the takeoff delay, to reach the predetermined minimum temperature.

A release signal (or also a takeoff signal) is output in block 209 after the takeoff delay has elapsed. After the takeoff delay has elapsed, the actual temperature of the exhaust aftertreatment system 10 generally corresponds to the predetermined minimum temperature. Correspondingly, the exhaust aftertreatment system 10 has a sufficient efficiency for pollutant reduction, so that the motor vehicle 100 may take off. For releasing (deactivating) the takeoff block, the control unit 11 outputs the release signal so that the driver can move the motor vehicle 100.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a motor vehicle comprising an internal combustion engine, the method comprising:
starting an internal combustion engine;
ascertaining a drive power requirement;
determining a takeoff delay for reaching a predetermined minimum temperature for an exhaust aftertreatment system, the predetermined minimum temperature being a function of a setpoint internal combustion motor drive power that is to be provided by the internal combustion engine to meet the drive power requirement; and
outputting, after the takeoff delay elapses, a release signal for releasing a takeoff block.

2. The method according to claim 1, wherein the drive power requirement is a function of at least one of the following:
navigation data;
vehicle position;
user history;
ambient temperature; and/or
vehicle operating mode.

3. The method according to claim 1, further comprising:
ascertaining a summed drive power for meeting the drive power requirement, the summed drive power comprising the setpoint internal combustion motor drive power and a setpoint motor drive power, where the setpoint motor drive power is to be provided by an electric machine of the motor vehicle.

4. The method according to claim 3, wherein the setpoint motor drive power is a function of a state of charge of an energy store of the motor vehicle that is coupled to the electric machine.

5. The method according to claim 3, wherein the setpoint motor drive power is a function of a drive strategy of the motor vehicle.

6. The method according to claim 1, further comprising:
heating the exhaust aftertreatment system to the predetermined minimum temperature using measures on the internal combustion engine side.

7. The method according to claim 1, wherein the takeoff delay is a function of an actual temperature of the exhaust aftertreatment system.

8. The method according to claim 1, wherein the takeoff delay is determined based on a characteristic map.

9. A control unit that is configured to carry out the method according to claim 1.

10. A motor vehicle comprising the control unit according to claim 9.
